(19) United States
(12) Patent Application Publication
(10) Pub. No.: US 2014/0274856 A1
(43) Pub. Date: Sep. 18, 2014

(54) FLOOR CLEANING KIT

(71) Applicants: Anthony Thompson, Morinville (CA); James H. Turnbull, Morinville (CA)

(72) Inventors: Anthony Thompson, Morinville (CA); James H. Turnbull, Morinville (CA)

(21) Appl. No.: 14/173,474

(22) Filed: Feb. 5, 2014

Related U.S. Application Data
(60) Provisional application No. 61/779,959, filed on Mar. 13, 2013.

(30) Foreign Application Priority Data
Mar. 13, 2013 (CA) 2809322

(51) Int. Cl. C11D 3/43

(52) U.S. Cl. CPC C11D 3/43
USPC 510/214

(57) ABSTRACT

A floor cleaning kit is described which contains a first cleaning composition that is formulated to reduce or remove film buildup caused by cleaning and polishing agents. The floor cleaning kit also contains a second cleaning composition formulated to clean with minimal film residue.

### FIELD

There is described a floor cleaning kit having two floor cleaner components that was developed to address problems with film buildup.

### BACKGROUND

Cleaning and polishing agents are intended to preserve and enhance a floor's shine so that the floor still looks like it did when it was first installed. Ironically, it is a film buildup caused by these same cleaning and polishing agents that, over time, results in the floor prematurely looking dull. There will hereinafter be described a two-component floor cleaner that was developed expressly to reduce the problem of a film buildup caused by cleaning and polishing agents.

### SUMMARY

There is provided a floor cleaning kit. The kit contains a first cleaning composition that is formulated to remove film buildup caused by cleaning and polishing agents. The first cleaning composition includes at least one solvent to break down film buildup and at least one surfactant or wetting agent to promote solvent penetration. Water is used as a dilutant and a water softener is added as required to ensure that the qualities of the water dilutant are not adversely effected by water quality. Instructions are included regarding application, activation interval, surface scrubbing, rinsing, and drying. The kit also contains a second cleaning composition formulated to clean with minimal film residue. The second cleaning composition includes at least 0.0008% by weight and not more than 0.1200% by weight of a linear alcohol surfactant and wetting agent, with the balance of the composition being deionized water used as a dilutant.

The first cleaning composition removes a substantial portion, if not all of the film buildup caused by cleaning and polishing agents. The second cleaning composition cleans while leaving minimal, if any, film residue.

### DETAILED DESCRIPTION

A floor cleaning kit will now be described. The floor cleaning kit contains a first cleaning composition that is formulated to reduce or remove film buildup caused by cleaning and polishing agents. The floor cleaning kit also contains a second cleaning composition formulated to clean with minimal film residue.

### Formulation of First Cleaning Composition:

The first cleaning composition contains a combination of solvents to break down film buildup caused by cleaning and polishing agents. The preferred solvents and preferred range of which are:
at least 0.1258% by weight and not more than 0.1268% by weight of Diethylelene Glycol Mono Butyl; and
at least 0.1430% by weight and not more than 0.1450% by weight of Propylene Glycol N-Butyl.

The combination of solvents is supplemented by at least 0.2000% by weight and not more than 0.2300% by weight of monoethanolamine.

The first cleaning composition also contains a combination of surfactants and wetting agents to promote solvent penetration. The preferred solvents and preferred range for application are:
at least 0.1500% by weight and not more than 0.1800% by weight of C9 linear alcohol Ethoxylate 6 mole; and
at least 0.0015% by weight and not more than 0.0016% by weight of Lithium 3-2 (perfluoroalkyl)proprioate.

Water is used as a dilutant and, subject to the inclusion of certain task-specific ingredients, completes the balance of the formulation or approximately of 99% by weight.

One task-specific ingredient is the addition of a water softener additive to “condition” the water. This is only necessary where the water is “hard.” There are a variety of water softeners that can be used. In the actual formulation, the water softener used was Sodium Nitrilotriacetate present in a preferred range of at least 0.0540% by weight and not more than 0.0580% by weight Another task specific ingredient is the addition of a defoamer to reduce foam formation during scrubbing. In the actual formulation, the defoaming agent was present within a preferred range of at least 0.0028% by weight and not more than 0.0030% by weight. There may also be added a dye to improve visual appeal to the consumer and a fragrance to enhance sensual appeal to the consumer. In the actual formulation, dye was present in a preferred range of 0.0001% by weight to not more than 0.0020% by weight. There was no fragrance in the actual formulation. The first cleaning composition is accompanied by instructions regarding application, activation interval, surface scrubbing, rinsing and drying.

### Application of First Cleaning Composition:

The preferred manner of application of the first cleaning composition is with a spray bottle. There is then an activation interval of approximately five minutes to allow the solvents to penetrate the film buildup with the assistance of the surfactants and wetting agents. After the activation interval, the floor is lightly scrubbed with a mop. The surface of the floor is then rinsed. The preferred manner of rinsing is with a bucket of water and a damp cloth. The floor is then allowed to dry prior to application of the second cleaning composition.

### Formulation of Second Cleaning Composition:

The second cleaning composition is formulated to clean with minimal film residue. The composition includes a linear alcohol C12-15 Ethoxolate within a preferred range of at least 0.0800% by weight and not more than 0.1000% by weight. The balance of the composition is deionized water used as a dilutant. It should be noted that deionized water is critical for a film free wash. As with the first cleaning composition, task-specific ingredients may be added such as a dye to improve visual appeal to the consumer and a fragrance to enhance sensual appeal to the consumer. In the actual formulation, dye was present in a preferred range of 0.0007% by weight to not more than 0.0009% by weight. In the actual formulation, a fragrance was present in a preferred range of 0.0050% by weight to not more than 0.0060% by weight.

### Application of Second Cleaning Composition:

The preferred manner of application of the second cleaning composition is by means of a spray bottle. The second cleaning composition may be spread with a cloth.

### Variations:

In order to make a full and complete disclosure, the actual formulation with “preferred” ranges of ingredients has been provided. It will be appreciated to a person skilled in the art that the practical range for these ingredients is much broader than the preferred ranges given. For most ingredients, there is a practical lower limit. This practical lower limit is where the ingredient ceases to be effective. For most ingredients, there is also a practical upper limit. This practical upper limit is where the ingredient could become harmful to the consumer using the product or to some types of floor substrates. There are also intermediate ranges in which the ingredient is effective and will not cause harm, but it is necessary in such quantities to perform its function and excessive amounts of the ingredient is just not cost effective. In other words, the sole purpose of using excessive amounts outside of the preferred range would be to avoid the patent. It will also be appreciated that, in order to avoid the patent, a person skilled in the art may consider increasing an amount of one solvent, surfactant or wetting agent and using a greater amount of another solvent, surfactant or wetting agent. There follows a useful broad range prepared to the best of the inventors' ability:

at least 0.1200% by weight and not more than 0.4500% by weight of Diethylelene Glycol Mono Butyl;

at least 0.1400% by weight and not more than 0.4700% by weight of Propylene Glycol N-Butyl;

at least 0.1400% by weight and not more than 0.3500% by weight of C9 linear alcohol Ethoxylate 6 mole;

at least 0.0014% by weight and not more than 0.0048% by weight of Lithium 3-2 (perfluoroalkyl)proprioate;

at least 0.2000% by weight and not more than 0.2300% by weight of monoethanolamine;

at least 0.0052% by weight and not more than 0.0145% by weight of Sodium Nitrilotriacetate;

at least 0.0022% by weight and not more than 0.0040% by weight of defoaming agent; and at least 0.0008% by weight and not more than 0.1200% by weight of a linear alcohol surfactant and wetting agent.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The illustrated embodiments have been set forth only as examples and should not be taken as limiting a purposive interpretation of the claims.

What is claimed is:

1. A floor cleaning kit, comprising, in combination:
a first cleaning composition to remove film buildup caused by cleaning and polishing agents, comprising:
at least one solvent to break down film buildup;
at least one surfactant or wetting agent to promote solvent penetration;
water as a dilutant;
a water softener additive; and
instructions regarding application, activation interval, surface scrubbing, rinsing, and drying; and
a second cleaning composition to clean with minimal film residue, comprising:
at least 0.0008% by weight and not more than 0.1200% by weight of a linear alcohol surfactant and wetting agent; and
a balance of deionized water as a dilutant.

2. The floor cleaning kit of claim 1, wherein the at least one solvent includes at least one of Diethylelene Glycol Mono Butyl Ether or Propylene Glycol N-Butyl.

3. The floor cleaning kit of claim 2, wherein both Diethylelene Glycol Mono Butyl and Propylene Glycol N-Butyl are present, comprising:
at least 0.1200% by weight and not more than 0.4500% by weight of Diethylelene Glycol Mono Butyl; and
at least 0.1400% by weight and not more than 0.4700% by weight of Propylene Glycol N-Butyl.

4. The floor cleaning kit of claim 3, wherein Diethylelene Glycol Mono Butyl and Propylene Glycol N-Butyl are present in a preferred range, comprising:
at least 0.1258% by weight and not more than 0.1268% by weight of Diethylelene Glycol Mono Butyl; and
at least 0.1430% by weight and not more than 0.1450% by weight of Propylene Glycol N-Butyl.

5. The floor cleaning kit of claim 1, wherein the at least one surfactant or wetting agent includes at least one of C9 linear alcohol Ethoxylate 6 mole and Lithium 3-2 (perfluoroalkyl) proprioate.

6. The floor cleaning kit of claim 5, wherein both C9 linear alcohol Ethoxylate 6 mole and Lithium 3-2 (perfluoroalkyl) proprioate are present, comprising:
at least 0.1400% by weight and not more than 0.3500% by weight of C9 linear alcohol Ethoxylate 6 mole; and
at least 0.0014% by weight and not more than 0.0048% by weight of Lithium 3-2 (perfluoroalkyl) proprioate.

7. The floor cleaning kit of claim 6, wherein the C9 linear alcohol Ethoxylate 6 mole and the Lithium 3-2 (perfluoroalkyl) proprioate are present in a preferred range, comprising:
at least 0.1500% by weight and not more than 0.1800% by weight of C9 linear alcohol Ethoxylate 6 mole; and
at least 0.0015% by weight and not more than 0.0016% by weight of Lithium 3-2 (perfluoroalkyl) proprioate.

8. The floor cleaning kit of claim 1, wherein the water softener is Sodium Nitrilotriacetate.

9. The floor cleaning kit of claim 8, wherein the Sodium Nitrilotriacetate is present in a range of at least 0.0052% by weight and not more than 0.0145% by weight.

10. The floor cleaning kit of claim 9, wherein the Sodium Nitrilotriacetate is present in a preferred range of at least 0.0540% by weight and not more than 0.0580% by weight.

11. The floor cleaning kit of claim 1, further including a defoaming agent.

12. The floor cleaning kit of claim 11, where the defoaming agent is present within a range of at least 0.0022% by weight and not more than 0.0040% by weight.

13. The floor cleaning kit of claim 12, where the defoaming agent is present within a preferred range of at least 0.0028% by weight and not more than 0.0030% by weight.

14. The floor cleaning kit of claim 1, wherein the linear alcohol surfactant and wetting agent is linear alcohol C12-15 Ethoxolate.

15. The floor cleaning kit of claim 14, wherein the linear alcohol C12-15 Ethoxolate is within a preferred range of at least 0.0800% by weight and not more than 0.1000% by weight.

16. The floor cleaning kit of claim 1, further including at least 0.1900% by weight and not more than 0.4500% by weight of monoethanolamine.

17. The floor cleaning kit of claim 16, wherein the monoethanolamine is present in a preferred range of at least 0.2000% by weight and not more than 0.2300% by weight.

18. The floor cleaning kit of claim 1, wherein the at least one solvent to break down film buildup, comprises:
at least 0.1200% by weight and not more than 0.4500% by weight of Diethylelene Glycol Mono Butyl; and
at least 0.1400% by weight and not more than 0.4700% by weight of Propylene Glycol N-Butyl;
supplemented by at least 0.1900% by weight and not more than 0.4500% by weight of monoethanolamine; and
the least one surfactant or wetting agent to promote solvent penetration, comprises:
at least 0.1400% by weight and not more than 0.3500% by weight of C9 linear alcohol Ethoxylate 6 mole; and
at least 0.0014% by weight and not more than 0.0048% by weight of Lithium 3-2 (perfluoroalkyl) proprioate.

19. The floor cleaning kit of claim 18, wherein the at least one solvent to break down film buildup, comprises a preferred range of:
at least 0.1258% by weight and not more than 0.1268% by weight of Diethylelene Glycol Mono Butyl; and
at least 0.1430% by weight and not more than 0.1450% by weight of Propylene Glycol N-Butyl,
supplemented by at least 0.2000% by weight and not more than 0.2300% by weight of monoethanolamine; and
the least one surfactant or wetting agent to promote solvent penetration, comprises a preferred range of:
at least 0.1500% by weight and not more than 0.1800% by weight of C9 linear alcohol Ethoxylate 6 mole; and
at least 0.0015% by weight and not more than 0.0016% by weight of Lithium 3-2 (perfluoroalkyl) proprioate.
